(19) United States
(12) Patent Application Publication
(10) Pub. No.: US 2017/0200246 A1
(43) Pub. Date: Jul. 13, 2017

(54) INTERACTIVE ENVIRONMENT FOR USER COMMENTARY AND REPORTING

(71) Applicants: Alireza Hedayati, Roslyn Harbor, NY (US); Wilson Gordillo, Brooklyn, NY (US); Md Hoque, Woodside, NY (US); Amir Hedayati, Windermere, FL (US)

(72) Inventors: Alireza Hedayati, Roslyn Harbor, NY (US); Wilson Gordillo, Brooklyn, NY (US); Md Hoque, Woodside, NY (US); Amir Hedayati, Windermere, FL (US)

(21) Appl. No.: 15/404,928

(22) Filed: Jan. 12, 2017

Related U.S. Application Data
(60) Provisional application No. 62/277,712, filed on Jan. 12, 2016.

(51) Int. Cl. G06Q 50/26; G06Q 10/10; G06F 17/30

(52) U.S. Cl. CPC G06Q 50/26; G06F 17/30867; G06Q 10/10; G06F 3/0483

(57) ABSTRACT

The embodiments herein relate to maintaining a database that includes incident report data and personnel commentary data. The incident report data includes data associated with law enforcement incident reports. The database is in communication with at least one of an interactive mobile application and an interactive website over a communications network. A user is provided with access to the database in response to receiving an access request from the user. The user accesses the database over the communications network via one or both of the interactive mobile application and the interactive website. The at least one of the interactive mobile application and the interactive website include add incident report data functionality, add personnel commentary data functionality, and search functionality for at least one of the incident report data and the personnel commentary data maintained in the database.

### BACKGROUND

Citizen interaction with law enforcement personnel and creating records of such interactions has become an important issue in society. With the increasing media attention to and monitoring of law enforcement contacts with individuals, it is necessary for both the citizens and the law enforcement personnel to keep accurate data on the interactions, including behavior that may be exhibited by law enforcement personnel and citizens alike.

### SUMMARY

According an embodiment of the present invention, a computer-implemented method comprises maintaining a database that includes incident report data and personnel commentary data. The incident report data includes data associated with law enforcement incident reports. The database is in communication with at least one of an interactive mobile application and an interactive website over a communications network. A user is provided with access to the database in response to receiving an access request from the user. The user accesses the database over the communications network via one or both of the interactive mobile application and the interactive website. The at least one of the interactive mobile application and the interactive website comprise add incident report data functionality, add personnel commentary data functionality, and search functionality for at least one of the incident report data and the personnel commentary data maintained in the database. The method is performed by at least one processing device comprising a processor operatively coupled to a memory.

According to another embodiment of the present invention, a system comprises at least one processing device comprising a processor operatively to a memory, a communications network in communication with the at least one processing device, and a database comprising incident report data comprising data associated with law enforcement incident reports and personnel commentary data. The database is in communication with at least one of an interactive mobile application and an interactive website over the communications network. The at least one of the interactive mobile application and the interactive website comprise add incident report data functionality, add personnel commentary data functionality, and search functionality for at least one of the incident report data and the personnel commentary data maintained in the database. The at least one processing device is configured to maintain the database, and provide a user with access to the database in response to receiving an access request from the user. The user accesses the database over the communications network via one or both of the interactive mobile application and the interactive web site.

According to yet another embodiment of the present invention, an article of manufacture comprises a processor-readable storage medium having encoded therein executable code of one or more software programs, wherein the one or more software programs when executed by one or more processing devices implement the steps of maintaining a database that includes incident report data and personnel commentary data. The incident report data includes data associated with law enforcement incident reports. The database is in communication with at least one of an interactive mobile application and an interactive website over a communications network. A user is provided with access to the database in response to receiving an access request from the user. The user accesses the database over the communications network via one or both of the interactive mobile application and the interactive website. The at least one of the interactive mobile application and the interactive website comprise add incident report data functionality, add personnel commentary data functionality, and search functionality for at least one of the incident report data and the personnel commentary data maintained in the database.

These and other exemplary embodiments of the invention will be described or become apparent from the following detailed description of exemplary embodiments, which is to be read in connection with the accompanying drawings.

### BRIEF DESCRIPTION OF THE DRAWINGS

Exemplary embodiments of the present invention will be described below in more detail, with reference to the accompanying drawings, of which:

FIG. 1 is a flow diagram of a process for accessing data, according to an exemplary embodiment.

FIG. 2A illustrates an exemplary image of at least a portion of a main homepage of an interactive mobile application and/or an interactive website, according to an embodiment.

FIG. 2B illustrates an exemplary image of at least a portion of a main homepage of an interactive mobile application and/or an interactive website, according to an embodiment.

FIG. 3A illustrates an exemplary image of at least a portion of a popular or hot news homepage of an interactive mobile application and/or an interactive website, according to an embodiment.

FIG. 3B illustrates an exemplary image of at least a portion of a popular or hot news search page of an interactive mobile application and/or an interactive website, according to an embodiment.

FIG. 3C illustrates an exemplary image of at least a portion of a popular or hot news page of an interactive mobile application and/or an interactive website, according to an embodiment.

FIG. 3D illustrates an exemplary image of at least a portion of a popular or hot news feedback page of an interactive mobile application and/or an interactive website, according to an embodiment.

FIG. 4 illustrates an exemplary image of at least a portion of an add new incident report data page of an interactive mobile application and/or an interactive website, according to an embodiment.

FIG. 5 illustrates an exemplary image of at least a portion of an add new personnel commentary data page of an interactive mobile application and/or an interactive website, according to an embodiment.

FIG. 6 illustrates an exemplary image of at least a portion of a view incident reports and reviews page of an interactive mobile application and/or an interactive website, according to an embodiment.

FIG. 7 illustrates an exemplary image of at least a portion of an incident report search page of an interactive mobile application and/or an interactive website, according to an embodiment.

FIG. 8A illustrates an exemplary image of at least a portion of a log-in page of an interactive mobile application and/or an interactive website, according to an embodiment.

FIG. 8B illustrates an exemplary image of at least a portion of a new user registration page of an interactive mobile application and/or an interactive website, according to an embodiment.

FIG. 9 illustrates an exemplary image of at least a portion of a search homepage of an interactive mobile application and/or an interactive website, according to an embodiment.

FIG. 10 illustrates an exemplary image of at least a portion of a help page of an interactive mobile application and/or an interactive website, according to an embodiment.

FIG. 11 illustrates an exemplary image of at least a portion of a miscellaneous page of an interactive mobile application and/or an interactive website, according to an embodiment.

FIG. 12 illustrates a computer system in accordance with which one or more embodiments of the invention can be implemented, according to an exemplary embodiment of the invention.

FIG. 13 illustrates a distributed communications/computing network in accordance with which one or more embodiments of the invention can be implemented, according to an exemplary embodiment of the invention.

### DETAILED DESCRIPTION

Exemplary embodiments of the invention will now be discussed in further detail with regard to an interactive website and mobile application and, in particular, to an online interactive website and mobile application configured to obtain users' reports of events as users' comments concerning personnel. In illustrative embodiments, the events are law enforcement events, such as crimes, and the personnel are law enforcement personnel or other public servants. The online interactive website and mobile application provide information, such as, for example, rankings, ratings, reviews, referrals and recommendations relating to personnel using a global computer network, and provide information, such as event reports, current events, profiles of personnel and quality ratings of personnel via a global computer network. This invention may, however, be embodied in many different forms and should not be construed as limited to the embodiments set forth herein.

As used herein, a (communications) network, can refer to, but is not necessarily limited to, a local area network (LAN), wide area network (WAN), cellular network, satellite network or the Internet. Network communication can be performed via one or more centralized servers or cloud data centers that receive, analyze and send data to and from one or client devices, such as, for example, smart phones, tablets or other computing devices, that, by way of example, are part of the network.

As used herein, the term “popular news” or “hot news” may be broadly defined as news that is being consumed by a large portion of the population, or news of a vital nature (e.g., breaking news).

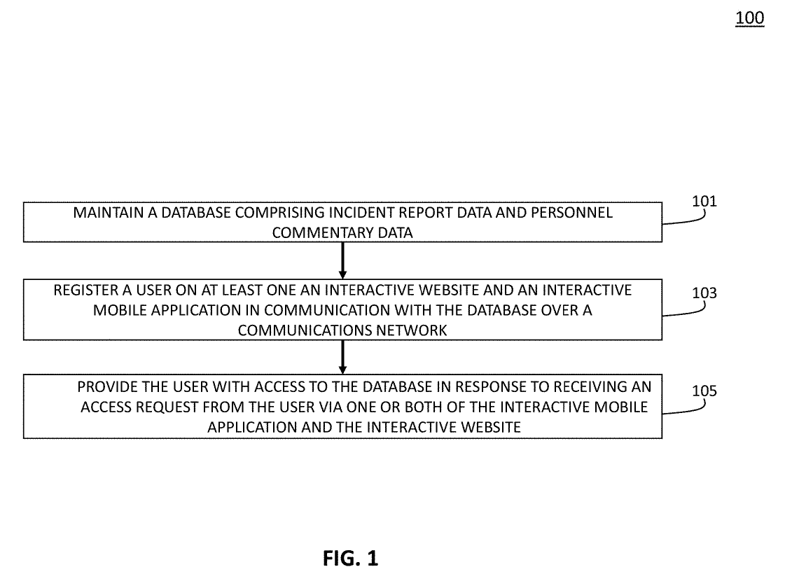

With respect to FIG. 1, a flow diagram is provided illustrating a process 100 for providing an interactive environment for user commentary and reporting, according to an exemplary embodiment of the invention. At step 101, a database comprising incident report data and personnel commentary data is maintained. In one embodiment, the database is stored on a cloud server. The incident report data may comprise data associated with law enforcement incident reports, such as crime reports, accident reports, etc. The personnel commentary data may include one or more of rankings, ratings, reviews, referrals and recommendations concerning personnel, such as law enforcement personnel, government officials, etc. Collectively, the personnel may referred to as “public servants.” The database is in communication with at least one of an interactive mobile application and an interactive website over a communications network. The interactive website and/or interactive mobile application provides information to users of the interactive website and/or the interactive mobile application, such as the incident report data and the personnel commentary data, via a global computer network.

At step 103, a user is registered and/or logged into the at least one of the interactive website and the interactive mobile application. If the user is a new user, then the user may need to enter an e-mail address and password to register a new account. In one embodiment, registering the user may comprise registering an account on the interactive web site and/or the interactive mobile application via at least one auxiliary account associated with the user (e.g., e-mail account, social media account, or other application account corresponding to the user). If the user is an existing user, the user may log in using the already registered e-mail address and password, or, in one embodiment, logging in may comprise logging into the account on the interactive website and/or the interactive mobile application via the at least one auxiliary account associated with the user (e.g., e-mail account, social media account, or other application account corresponding to the user). In the event that the user cannot remember log-in credentials, there may be a “forget password” link where user can enter email address and system will send the password to the email address that it is associated with.

At step 105, the user is provided with access to the database in response to receiving an access request from the user. The user accesses the database over the communications network via one or more of the interactive mobile application and the interactive website. The interactive mobile application and/or the interactive website comprises add incident report data functionality, add personnel commentary data functionality, and search functionality for at least one of the incident report data and the personnel commentary maintained in the database.

In one embodiment, providing the user access to the database at step 105 comprises receiving a request from the user to add incident report data in response to user activation of the add incident report data functionality, and providing the user with an add incident report data page comprising one or more incident report page fields in response to the received request. Illustratively, when a user selects an add incident report data button, then a report an incident page will appear, through which a user can add an incident report. A user can report a crime or other event, such as, for example, a traffic accident, and upload media (e.g., images or video) and write a synopsis of the event that will be visible by other users. Adding an incident can depend on one or more of the following fields:
i) Country (May pull country information through API from the web server)
ii) State (May pull state information through API from the web server)
iii) County/Parish (May pull county/parish information through API from the web server)
iv) Provide an Incident Title (simple text field)
v) Provide an Incident Date (simple text field or dynamic field)
vi) Provide an Incident Time (simple text field or dynamic field)
vii) Provide an Incident Location (simple text field)
viii) Enter Incident Details (a text area field)
ix) Attach media file (A User may upload a media file including an .mp3, .jpg, .doc, etc.).

In one embodiment, providing the user access to the database at step 105 comprises receiving a request from the user to add personnel commentary data in response to user activation of the add personnel commentary data functionality, and providing the user with an add personnel commentary data page comprising one or more one or more personnel commentary page fields in response to the received request. Illustratively, when a user selects an add personnel commentary data button, then a review page will appear through which a user can add a review. Adding personnel commentary can depend on one or more of the following fields:
i) Country (May pull country information through an application program interface (API) from the web server)
ii) State (May pull state information through API from the web server)
iii) County/Parish (May pull county/parish information through API from the web server)
iv) Agency (simple text field)
v) Review for (Options could be static or dynamic)
vi) Name/car/badge (a simple text field)
vii) Rating (options could be static or dynamic based upon a provided scale, i.e. e.g., 1-5 where 5 is equal to an “excellent rating” and 1 is equal to a “poor” rating).
viii) Feedback (a text area field)
ix) Attach media file (a user may upload a media file including an .mp3, .jpg, .doc, etc.).
   In one embodiment, a details review page may be provided associated with an entity being reviewed. The details review page may have a title which is the “Entity” that the user wanted to see the review. The details review page may further include
a) Experience Graph: A 3D bar showing total number of Positive review with Green bar, total number of Neutral review with Yellow bar and total number of Negative review with Red bar.
b) Recommend to a friend: A 3D Green Thumbs Up with total number and a Red Thumbs Down with total number
c) Comments: First 2 comments each with 1 line. At the end of the line, there will be a “Details” link that will direct the user to the Details page of all the Comments regarding that entity.
   This page may also show a link of the website of the entity, if it exists. This page may also include an “Add Review Button for Existing Entity” button. This button may cause a page to add a review for an existing entity to be displayed. This page may include questions associated with the entity for the user to answer. For example, this page may include:
1. A question with only 1 option to choose from 3 options. Example: What is your experience about the service? Options are: Positive, Neutral, Negative; and
2. A question with only 1 option to choose from 2 options. Example: Would you recommend to a friend? Options are: Yes or No
   This page may also include a Back button to go to the previous page; a Home button to go back to the Home page; a Help button to go to the Help page; etc.

In one embodiment, providing the user access to the database at step 105 comprises receiving a request from the user to search the database for one or more of incident report data and personnel commentary data in response to user activation of the search functionality, and providing the user with a search page comprising one or more search page fields in response to the received request. Illustratively, when a user selects at least a portion of a search button, then a search page will appear. The user can select to search incident reports or reviews, through which a user can search any incident report and/or review. Depending upon the initial selection, (i.e. incident report or review), all reviews or incident reports will populate. A user can additionally search one or more of the following fields:
i. Country
ii. State
iii. Zip code
iv. Review for (e.g., individual (e.g., police officer), precinct, vehicle, badge number, others)
v. Name/car/badge number

b. When a user clicks to search, then related items according to that search will show in a search page from where a user can select to view detail (rating, recommendation, comment number, media upload) of that review. Now in that page, if user selects add review, then he can key in another review for that item where he can key in the following fields:
i. Rating (e.g., excellent, good, nothing, poor)
ii. Recommended or not
iii. Add description/comment/story (text area)
iv. Add media files

But in the search panel if a user does not find a suitable item, then he can add another item with the following fields
i. Country
ii. State
iii. County/Parish
iv. Review for (individual, precinct, vehicle, badge number, others)
v. Name/car/batch (text field)
vi. Rating (excellent, good, nothing, poor)
vii. Recommended or not
viii. Add description/comment/story (text area)
ix. Add media files

The interactive mobile application and/or the interactive website may further comprise popular (“hot”) data item search functionality. In one embodiment, providing the user access to the database at step 105 comprises receiving a request from the user to search the database for a popular data item in response to user activation of the popular data item search functionality, and providing the user with an popular data item search page comprising one or more popular data item search page fields in response to the received request. Illustratively, when a user selects a popular or “hot” news button, then a search hot news page will appear, through which a user can search any hot news item. A user can search one or more of the following fields:
i. Country
ii. State
iii. County/Parish
iv. Popularity (e.g., Most popular, Moderate, Standard)
v. Keyword (e.g. News title)
v. News date
   When a user clicks to search, then related items according to that search will show in a search page from where user can select to view detail (title, number of feedback, number of media files) of that Hot news. Now in that page, if user selects add feedback, then he can key in another Hot news for that item where he can key in one or more of the following fields:
i. Feedback (text area)
ii. Add media files
   But in the search panel, if the user does not find a suitable item, then the user can add another item with one or more of the following fields:
i. Country
ii. State
iii. Popularity (e.g., Most popular, Moderate, Standard)
iv. News title
v. News date
vi. Feedback (text area)
vii. Add media files
   In the Hot News section, the user can key in one or more of the following fields:
i. Country
ii. State
iii. Popularity (e.g., choose from 3 different option from the admin panel for a user to choose which one they want: Most popular, Moderate, Standard (not necessarily limited to three options)
iv. Keyword (simple text field): associate to make the search faster
v. Date: (e.g., “an event date/crime date”, which user can add or change the date from a date picker.
   A user can report hot news, upload media (e.g., images or video) and write a synopsis of the news event that will be visible by other users. Alternatively, a user can read other hot news items uploaded by an administrator or other users.

In accordance with an embodiment, the interactive website and/or the interactive mobile application can include an interface, such as an icon on a screen or a button on a mobile device, which triggers a video recording function of the mobile device, so that the device will commence recording a video of a target at which the device is pointed and/or oriented. The mobile device may be, but is not limited to, a mobile phone, tablet, smart watch or smart glasses, A screen of the device can be inactive (e.g., black) and lacking any image or display and/or indicator lights, so it does not appear that the device is in a recording mode. According to an embodiment, a file including the recorded video is automatically saved on the device, and/or automatically sent via a network, including, but not limited to, a local area network (LAN), wide area network (WAN), cellular network, ad hoc network, wireless ad hoc network, WANET, satellite network or the Internet, to a server and saved at the server. The saving of the video on the server and/or on the device can occur simultaneously with, substantially simultaneously or immediately after taking the video. The sending of the video to the server is preferably performed as the video is taken so that a copy of the video is protected in the event that the mobile device is lost, broken or otherwise compromised.

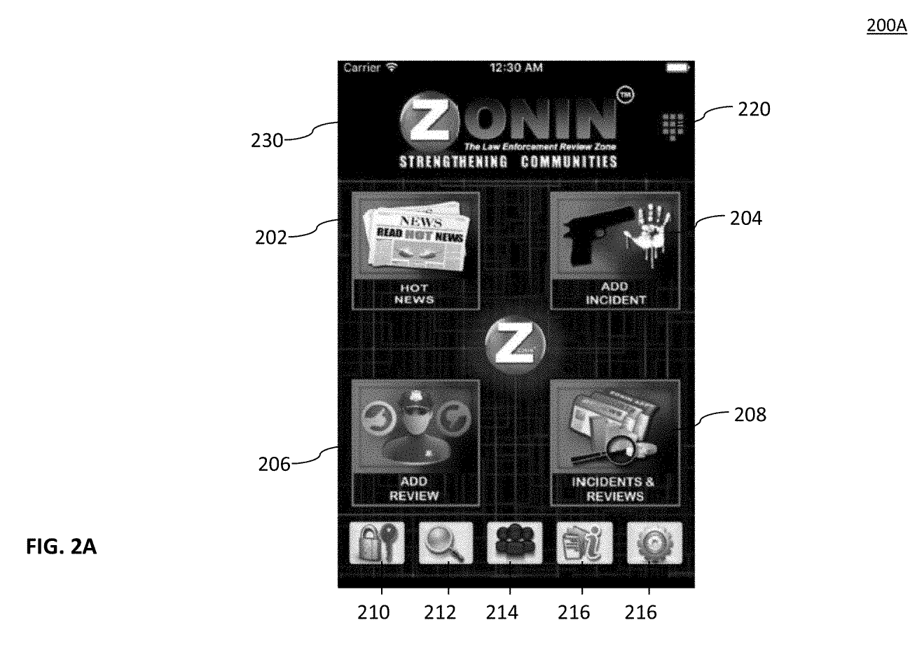

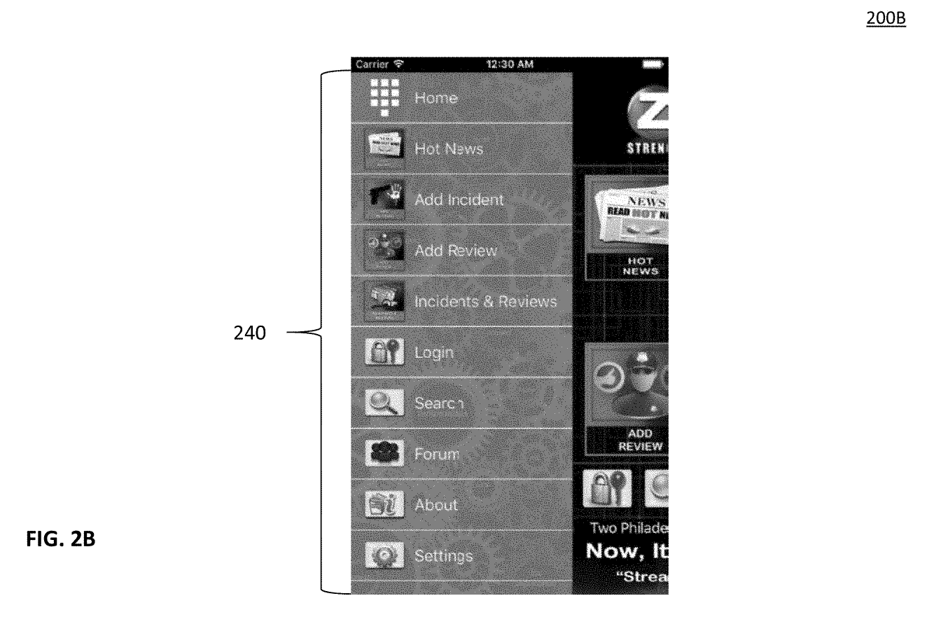

FIG. 2A illustrates an exemplary image of at least a portion of a main homepage of an interactive mobile application and/or an interactive website, according to an embodiment. As shown in FIG. 2A, page 200A includes various “main” buttons, including but not limited to Hot News 202, Add Incident 204, Add Review 206, and Incidents & Review 208. Main homepage 200A may include additional buttons, including one or more of Login 210, Search 212, Forum 214, About 216, and Settings 218. Main homepage 200A may include a button to return to the main homepage, Home 220. Main homepage 200A may include banner 230. Banner 230 may include, for example, a logo/name of the website/mobile application and a logo/name of the company.

FIG. 2B illustrates an exemplary image of at least a portion of a main homepage of an interactive mobile application and/or an interactive website, according to an embodiment. As shown, page 200B depicts list 240, which illustrates a list comprising buttons 202-220 from FIG. 2A.

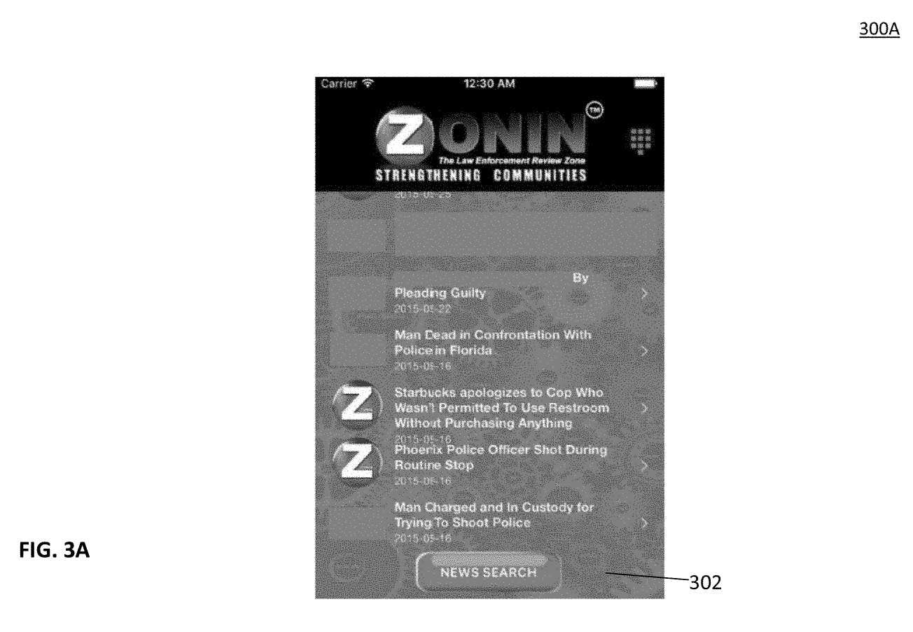

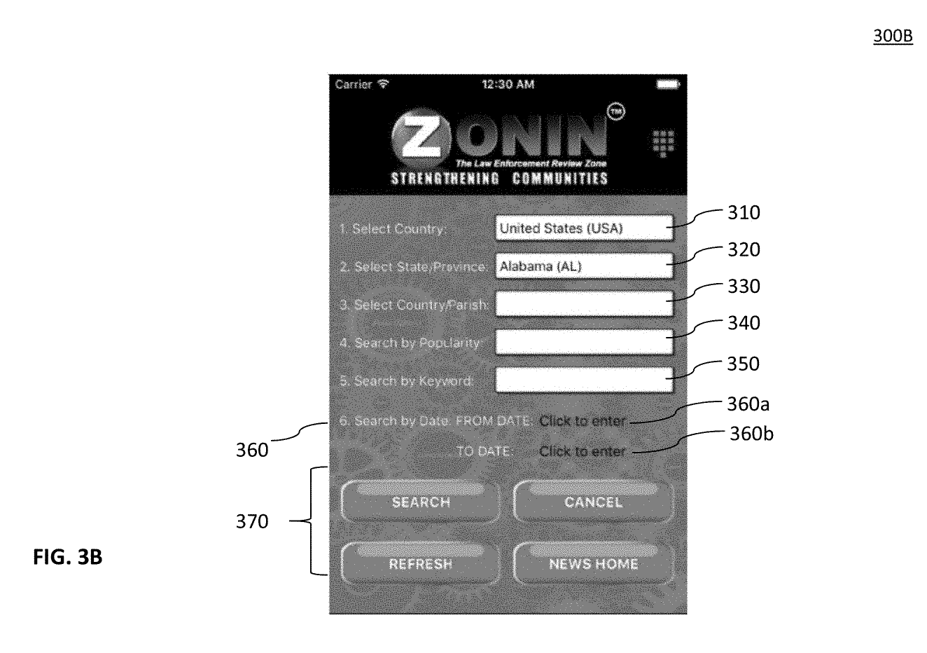

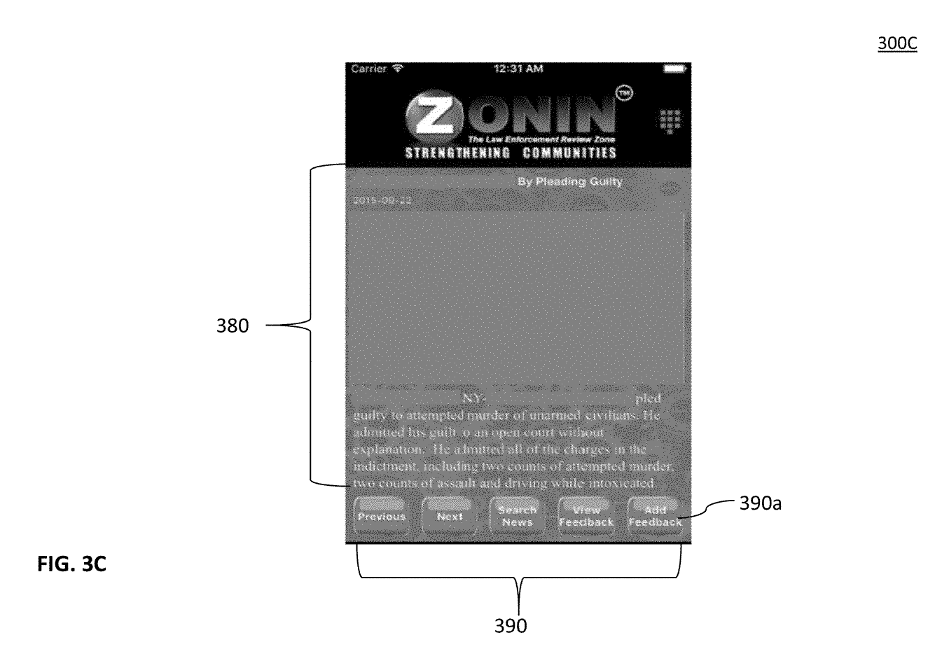

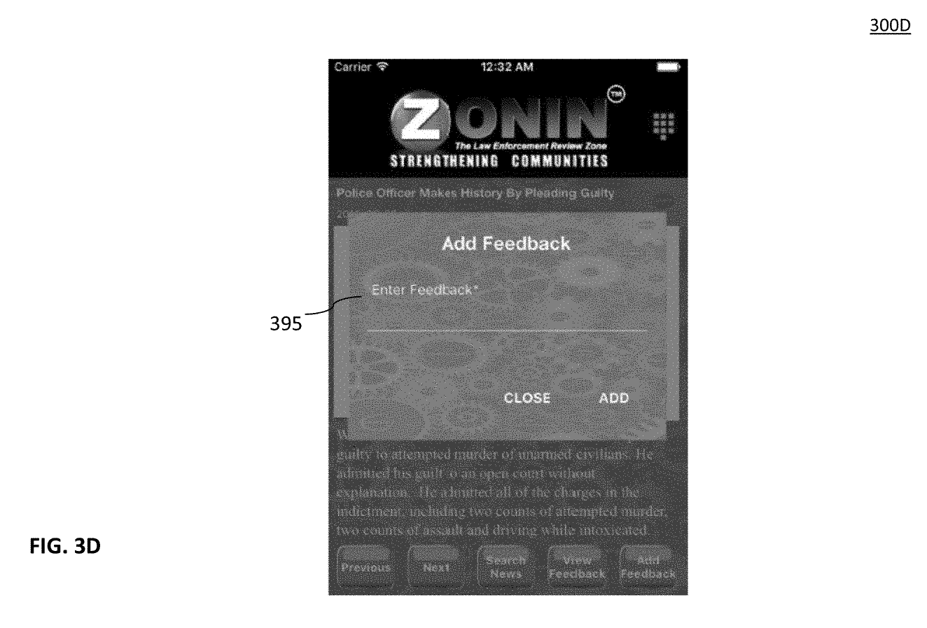

FIG. 3A illustrates an exemplary image of at least a portion of popular or hot news homepage of an interactive mobile application and/or an interactive website, according to an embodiment. As shown, page 300A lists popular or hot news stories. Page 300A may include, for example, News Search button 302. A user may search for popular or hot news by selecting (e.g., by clicking on or pressing) News Search button 302, which causes the interactive mobile application or interactive website to display a popular or hot news search page, as will be discussed in further detail with reference to FIG. 3B.

FIG. 3B illustrates an exemplary image of at least a portion of a popular or hot news search page of an interactive mobile application and/or an interactive website, according to an embodiment. As shown, page 300B comprises various search criteria represented as search fields, including Select Country 310, Select State/Province 320, Select County/Parish 330, Search by Popularity 340, Search by Keyword 350 and Search by Date 360. Search by Date 360 may include From Date 360a and To Date 360b in order for the user to search by a date range. At least one of the fields 310-360 may need to be filled in order to perform a filtered search of popular or hot news. Page 300B may further include set of buttons 370. As shown in this illustrative embodiment, set of buttons 370 may include a Search button, a Refresh button, a Cancel button, and a News Home button. Selecting the Search button causes a search to be performed within the database for entries satisfying the search criteria. A user may return to page 300A of FIG. 3A by selecting the News Home button.

FIG. 3C illustrates an image of an at least a portion of an exemplary popular or hot news page of an interactive mobile application and/or an interactive website, according to an embodiment. As shown, page 300C comprises body 380 that includes a popular or hot news story. Page 300C may further comprise set of buttons 390, including Add Feedback button 390a. A user may add feedback for the popular or hot news story by selecting Add Feedback button 390a, which causes the interactive mobile application or interactive website to display an add feedback page, as will be discussed in further detail with reference to FIG. 3D.

FIG. 3D illustrates an exemplary image of at least a portion of a popular or hot news add feedback page of an interactive mobile application and/or an interactive website, according to an embodiment. As shown in page 300D, after selecting Add Feedback button 390a, prompt 395 is displayed that includes a field to enter feedback. A user may either add feedback, or close prompt 395 without adding feedback.

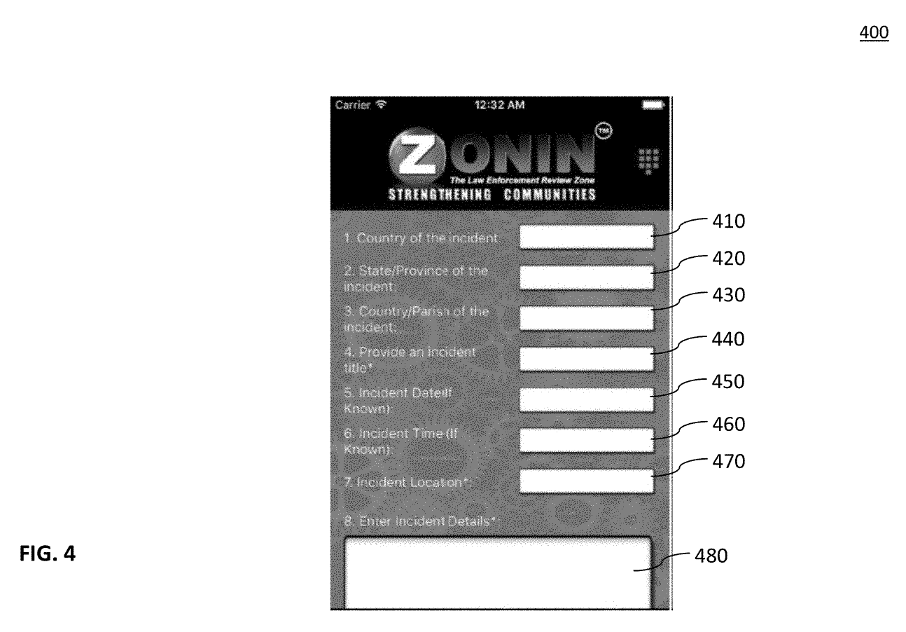

FIG. 4 illustrates an exemplary image of at least a portion of an add new incident report data page of an interactive mobile application and/or an interactive website, according to an embodiment. As shown, page 400 comprises various fields, including Country of the incident 410, State/Province of the incident 420, County/Parish of the incident 430, Provide an incident title 440, Incident date (if known) 450, Incident time (if known) 460, Incident Location 470 and Enter incident Details 480. At least one of the fields 410-480 may need to be filled in order for the user to add a new incident report. For example, one or more of these fields may be mandatory fields. For example, the fields denoted by a (*) are mandatory fields.

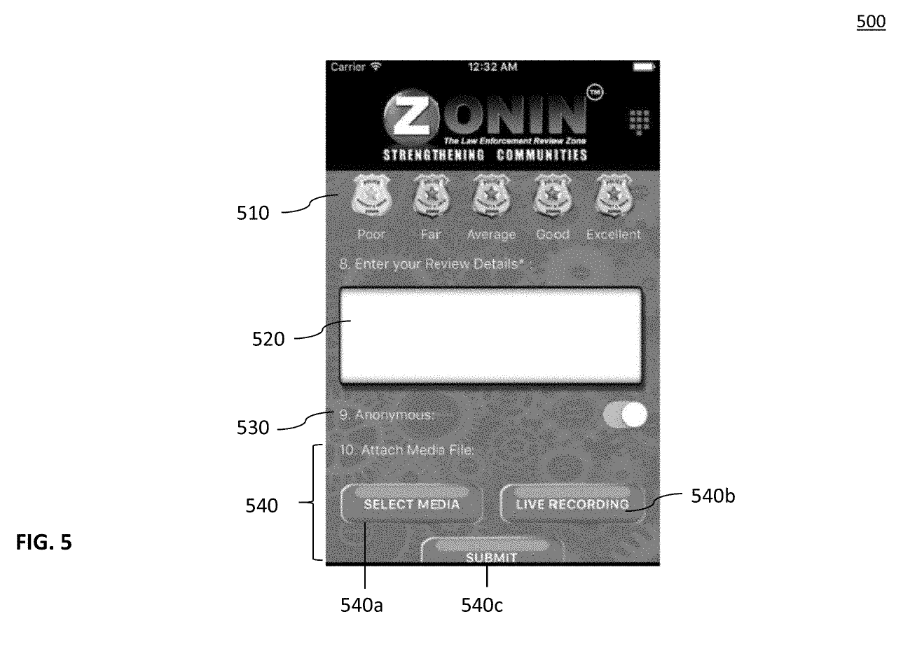

FIG. 5 illustrates an exemplary image of at least a portion of an add new personnel commentary data page of an interactive mobile application and/or an interactive website, according to an embodiment. As shown, page 500 comprises various fields, including Rating 510, Enter your Review Details 520, Anonymous 530 and Attach Media File 540. Rating 510 is shown in this illustrative embodiment as a scale including Poor, Fair, Average, Good and Excellent. A user selects one of these ratings to rate the particular personnel associated with the commentary. It is to be understood that the rating system shown in FIG. 5 is not to be considered limiting. A user can enter additional comments or details in Enter your Review Details 520, such as to elaborate on the reasoning behind the particular rating selected at Rating 510. A user can choose to be anonymous by toggling or otherwise selecting to be anonymous via Anonymous 530. A user can choose to attach a media file corresponding to the personnel associated with the commentary by choosing an option from Attach Media File 540. For example, the user can upload previously recorded media by selecting Select Media button 540a or film a live recording by selecting Live Recording button 540b. The user can then attach the media file, either uploaded or live recorded, by selecting Submit button 540c.

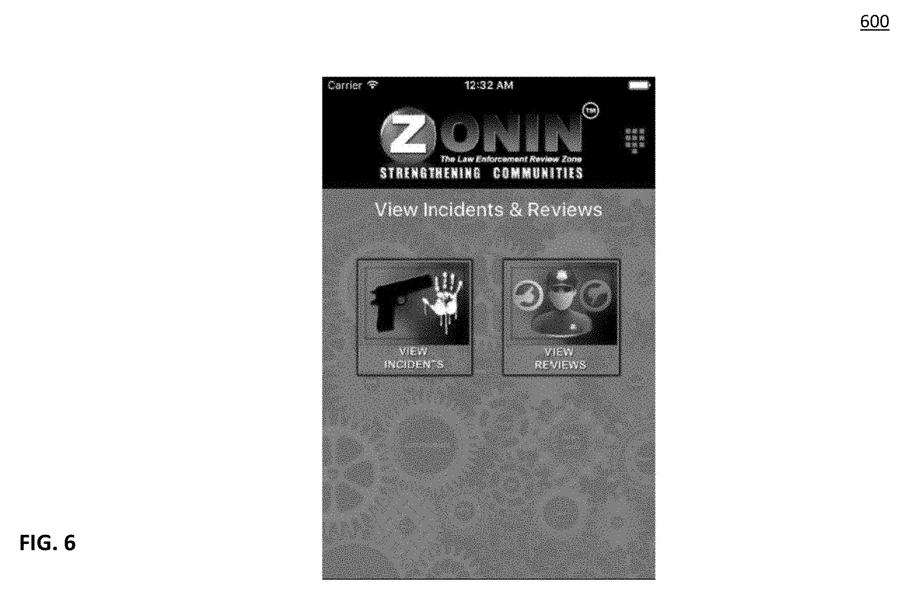

FIG. 6 illustrates an exemplary image of at least a portion of a view incident reports and reviews page of an interactive mobile application and/or an interactive website, according to an embodiment. As shown, page 600 includes View Incidents button 610 and View Reviews button 620. A user may view incident reports by selecting View Incidents button 610, and view personnel reviews by selecting View Reviews button 620.

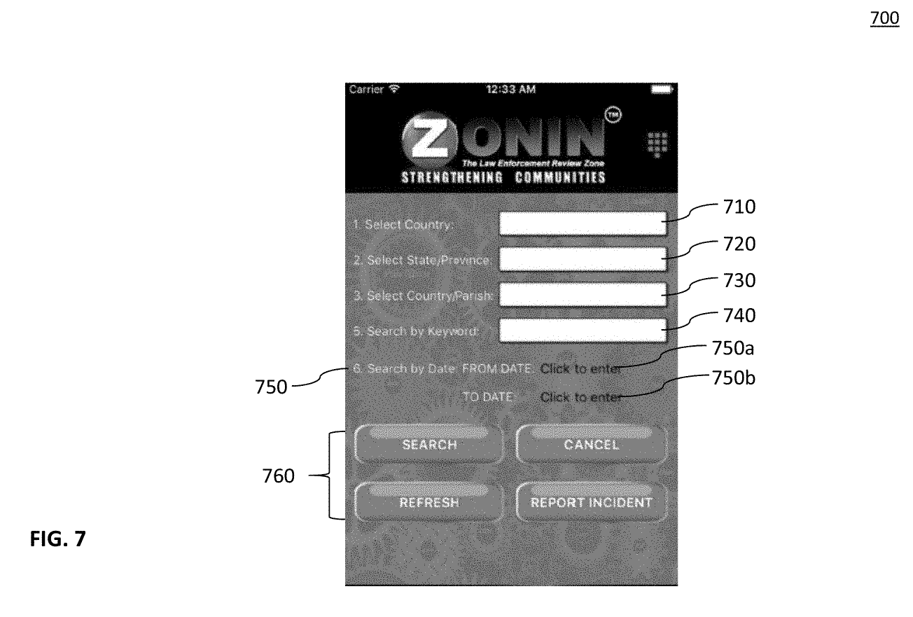

FIG. 7 illustrates an exemplary image of at least a portion of an incident report search page of an interactive mobile application and/or an interactive website, according to an embodiment. As shown, page 700 comprises various fields, including Select Country 710, Select State/Province 720, Select County/Parish 730, Search by Keyword 740, and Search by Date 750. Search by Date 750 may include From Date 750a and To Date 750b in order for the user to search by a date range. At least one of the fields 710-750 may need to be filled in order to perform a filtered search of popular or hot news. Page 700 may further include set of buttons 760. As shown in this illustrative embodiment, set of buttons 760 may include a Search button, a Refresh button, a Cancel button, and a Report Incident button. User selection of the Report Incident button may cause the interactive website or interactive mobile application to go to page 400 of FIG. 4 in order for the user to add a new incident report.

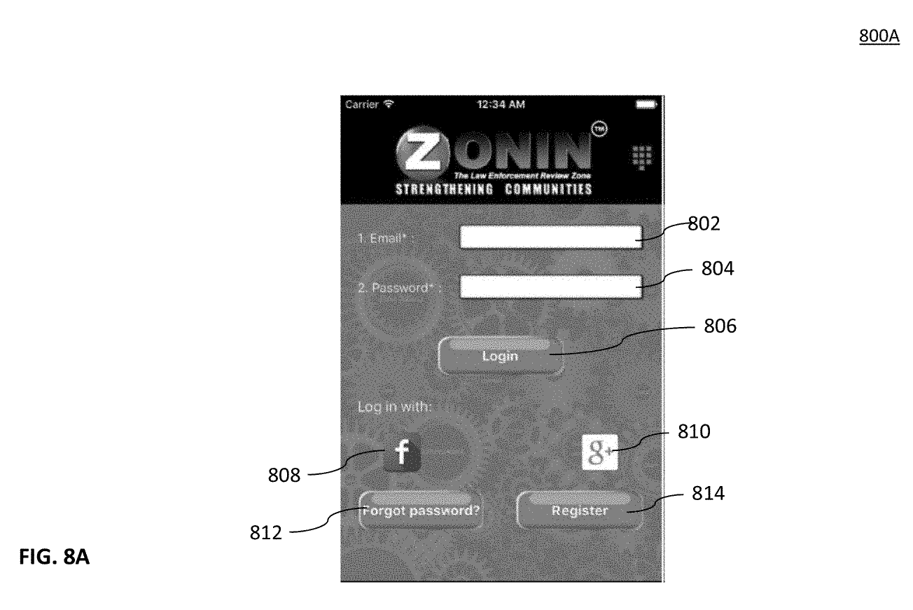

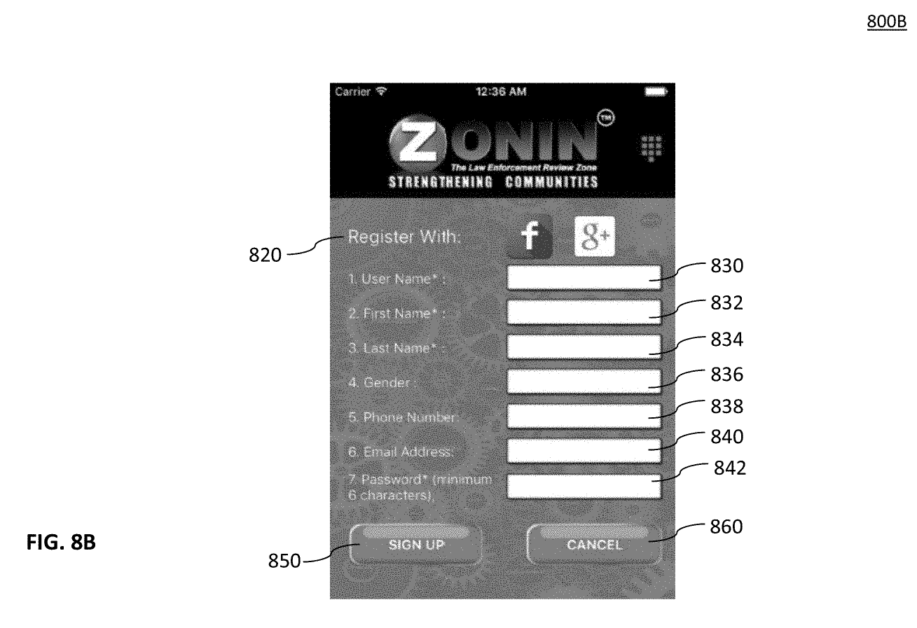

FIG. 8A illustrates an exemplary image of at least a portion of a login page of an interactive mobile application and/or an interactive website, according to an embodiment. As shown, page 800A includes various login fields, such as Email 802 and Password 804 for the user to enter his or her login credentials. After entering the login credentials, the user can login by selecting Login button 806. In one embodiment, the user may login using one or more auxiliary accounts associated with the user. For example, the user may link one or more auxiliary accounts, such as social media accounts, to an account with the interactive website or interactive mobile application for login purposes. As shown in this illustrative embodiment, the user may login with his or her Facebook® account by selecting button 808, or his or her Google® account by selecting button 810. In the event that a user forgets his or her password, the user may select Forgot Password button 812 to initiate a password recovery protocol. If the user does not have an account with interactive website or interactive mobile application, the user can register for an account by selecting Register button 814 to open a new user registration page. Further details regarding the new user registration page will now be discussed with reference to FIG. 8B.

FIG. 8B illustrates an exemplary image of at least a portion of a new user registration page of an interactive mobile application and/or an interactive website, according to an embodiment. For easy registration, a user may register an account with an auxiliary account. For example, as shown in page 800B, a user may register with his or her Facebook® account or Google® account. However, these auxiliary account choices should not be considered limiting. Alternatively, a user can register an account manually with the interactive website or interactive mobile application. As shown, page 800B includes various registration fields for manual registration, such as User Name 830, First Name 832, Last Name 834, Gender 836, Phone Number 838, Email Address 840 and Password 842. The password may require a minimum number of characters. As shown in this illustrative embodiment, the minimum number of characters the password can be is 6. However, this number should not be considered limiting. One or more of these fields may be mandatory fields. For example, the fields denoted by a (*) are mandatory fields. After entering all the information in the fields, the user may register by selecting Sign Up button 850. In one embodiment, the user may be required to verify his or her new account. For example, the user may have to enter a verification code sent to the user after selecting Sign Up button 850. The verification code may be sent via email to an email address associated with the user, text message to a mobile device associated with the user, or any other medium capable of transmitting the verification code to the user. The user may then enter the verification code to complete the registration process. The user may cancel his or her registration by selecting Cancel button 860.

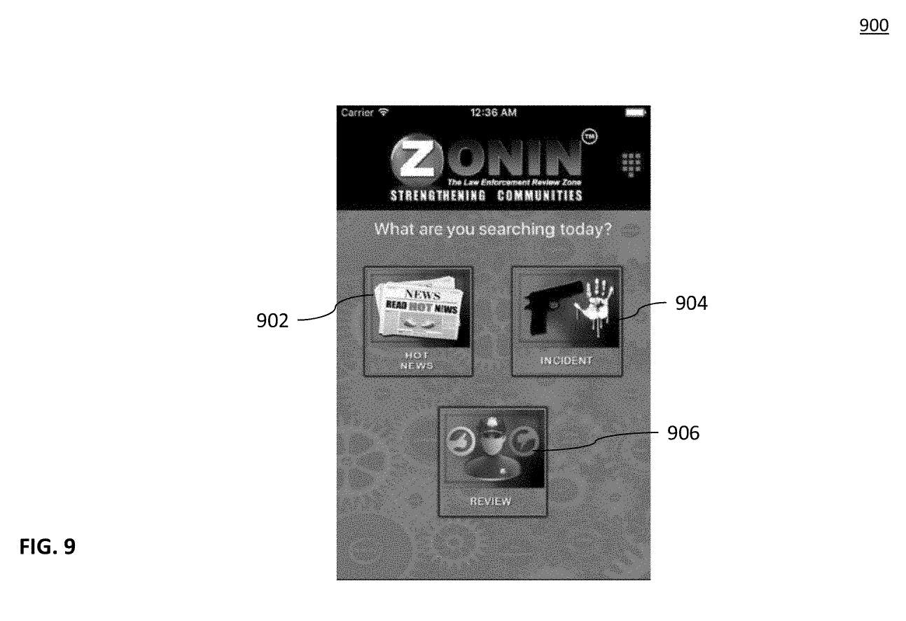

FIG. 9 illustrates an exemplary image of at least a portion of a search homepage of an interactive mobile application and/or an interactive website, according to an embodiment. As shown, page 900 includes various buttons to initiate searches, including Hot News 902, Incident 904 and Review 906. User selection of Hot News 902 causes the interactive website or interactive mobile application to display a hot news search page, such as page 300B from FIG. 3B. User selection of Incident 904 causes the interactive website or interactive mobile application to display an incident report search page, such as page 700 of FIG. 7. User selection of Review 904 causes the interactive website or interactive mobile application to display a review search page.

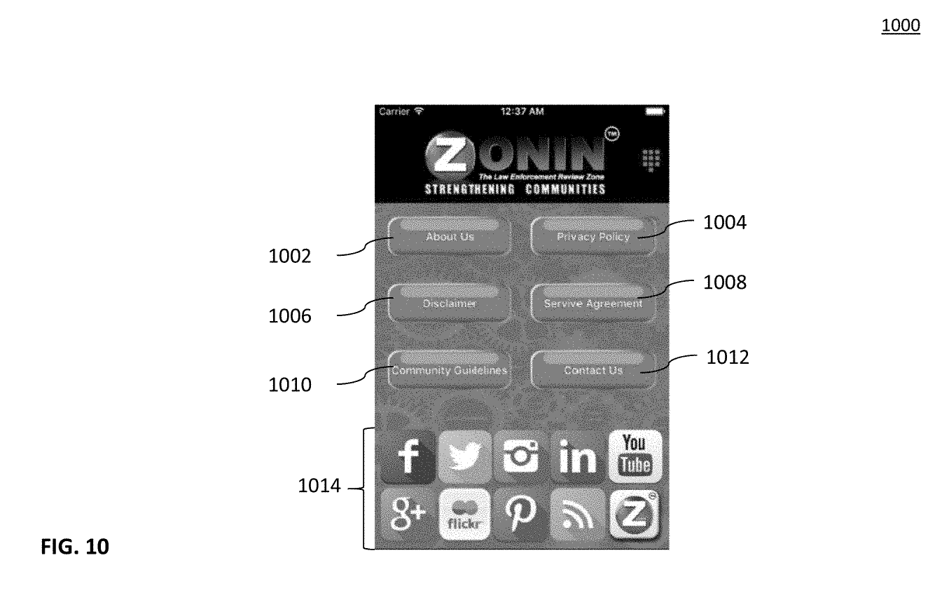

FIG. 10 illustrates an exemplary image of at least a portion of a help page of an interactive mobile application and/or an interactive website, according to an embodiment. As shown, page 1000 includes various buttons, including About Us 1002, Privacy Policy 1004, Disclaimer 1006, Service Agreement 1008, Community Guidelines 1010, and Contact Us 1012. User selection of About Us 1002 causes the interactive website or interactive mobile application to display an about us page for the user to read. The about us page may illustratively include details pertaining to the creators of the interactive website and/or the interactive mobile application. User activation of Privacy Policy 1004 causes the interactive website or interactive mobile application to display a privacy policy page for the user to read. User activation of Disclaimer 1006 causes the interactive website or interactive mobile application to display a disclaimer page for the user to read. The disclaimer page may illustratively recite the following: “If there is an emergency, please call 911 or your local law enforcement agency.” User activation of Service Agreement 1008 causes the interactive website or interactive mobile application to display a service agreement page for the user to read. User activation of Community Guidelines 1010 causes the interactive website or interactive mobile application to display a community guidelines page for the user to read. User activation of Contact Us 1012 causes the interactive website or the interactive mobile application to display a contact us page for the user to read. The contact us page may comprise information for contacting a customer service representative. In one embodiment, the contact us page may include one or more of a send feedback icon and a rate website/application icon. User activation of the send feedback icon causes the interactive website or interactive mobile application to display a page comprising send feedback fields that illustratively include “Name,” “Email,” “Phone,” and “Feedback.” In one embodiment, and as shown, page 1000 may further comprise set of buttons 1014 associated with one or more external websites. For example, set of buttons 1014 may include buttons that link the user to social media web sites.

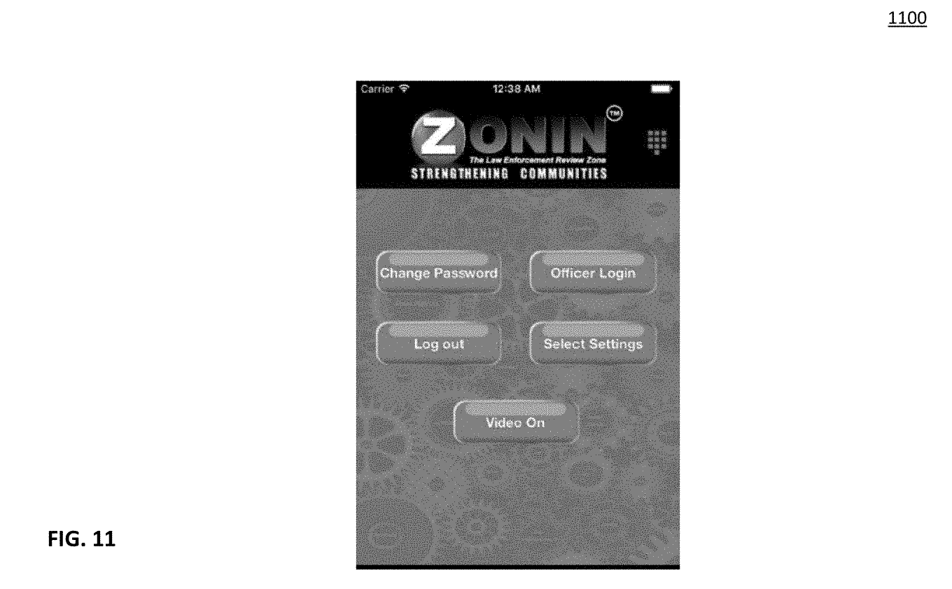

FIG. 11 illustrates an exemplary image of at least a portion of a miscellaneous page of an interactive mobile application and/or an interactive website, according to an embodiment. As shown, page 1100 includes various buttons, including Change Password 1102, Office Login 1104, Log out 1106, Select Settings 1108, and Video On 1110. User activation of Change Password 1102 causes the interactive website or interactive mobile application to display a page comprising change password fields that illustratively include “Recent Password,” “New Password,” and “Confirm Password.” In one embodiment, user activation of Log Out 1106 causes the interactive website or interactive mobile application to issue a prompt confirming the user's desire to log out. For example, the prompt may include the phrase “Do you want to log out,” along with a “No” option and a “Yes” option. User activation of Select Settings 1108 causes the interactive website or interactive mobile application to display a page comprising setting selection fields. For example, the setting selection fields may include fields such as “Language,” “Country,” “State/Province,” and “County/Parish.”

Although explicitly shown herein, one or more of the pages described above in FIGS. 2-11 may include space for one or more advertisements. The advertisement space may be tiered advertisement space. For example, standard advertisement space may be a small space for displaying a small banner or link, while premier advertisement space may be a larger space for displaying a larger banner, which may include company name and logo, an image, contact information, and/or an animated banner.

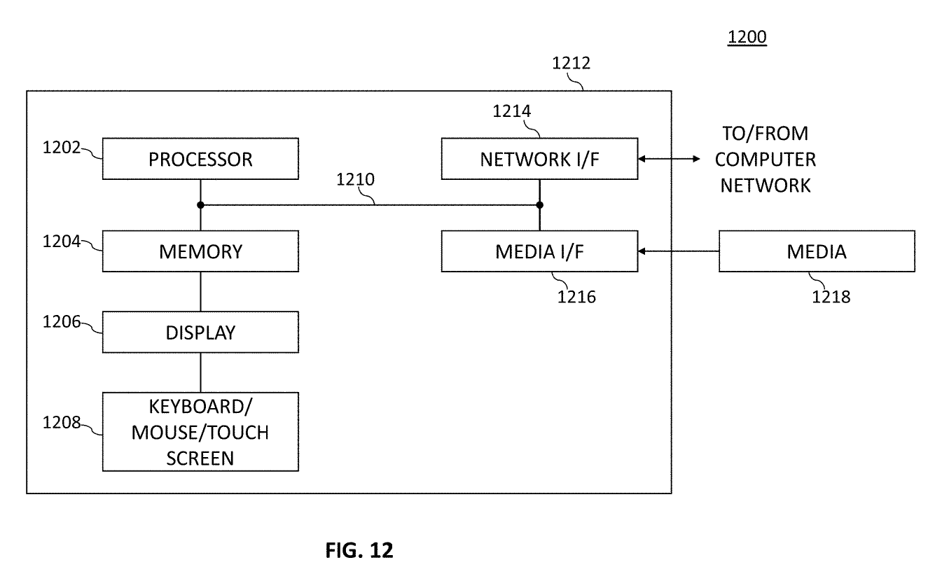

FIG. 12 illustrates a computer system 1200 in accordance with which one or more embodiments of a model management system can be implemented. That is, one, more than one, or all of the components and/or functionalities shown and described in the context of FIGS. 1-11 can be implemented via the computer system depicted in FIG. 12.

By way of illustration, FIG. 12 depicts a processor 1202, a memory 1204, and an input/output (I/O) interface formed by a display 1206 and a keyboard/mouse/touchscreen 1208. More or less devices may be part of the I/O interface. The processor 1202, memory 1204 and I/O interface are interconnected via computer bus 1210 as part of a processing unit or system 1212 (such as a computer, workstation, server, client device, etc.). Interconnections via computer bus 1210 are also provided to a network interface 1214 and a media interface 1216. Network interface 1214 (which can include, for example, transceivers, modems, routers and Ethernet cards) enables the system to couple to other processing systems or devices (such as remote displays or other computing and storage devices) through intervening private or public computer networks (wired and/or wireless). Media interface 1216 (which can include, for example, a removable disk drive) interfaces with media 1218.

The processor 1202 can include, for example, a central processing unit (CPU), a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1202. Memory 1204 (or other storage device) having such program code embodied therein is an example of what is more generally referred to herein as a processor-readable storage medium. Articles of manufacture comprising such processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1204 may comprise electronic memory such as random access memory (RAM), read-only memory (ROM) or other types of memory, in any combination. The one or more software programs when executed by a processing device such as the processing unit or system 1212 causes the device to perform functions associated with one or more of the components/steps of system/methodologies in FIGS. 1-11. One skilled in the art would be readily able to implement such software given the teachings provided herein. Other examples of processor-readable storage media embodying embodiments of the invention may include, for example, optical or magnetic disks.

Still further, the I/O interface formed by devices 1206 and 1208 is used for inputting data to the processor 1202 and for providing initial, intermediate and/or final results associated with the processor 1202.

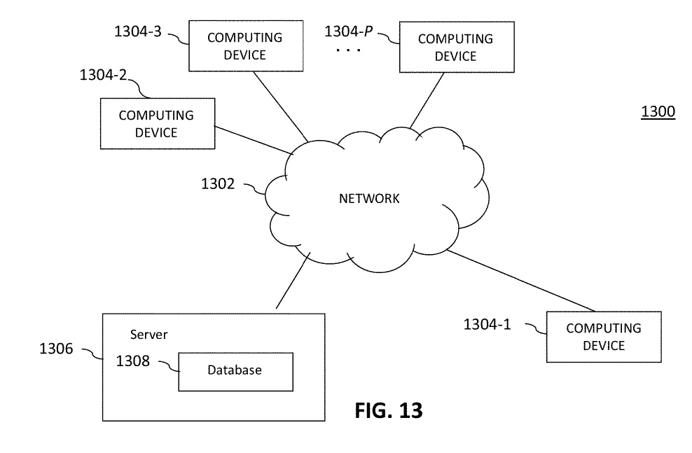

FIG. 13 illustrates a distributed communications/computing network (processing platform) in accordance with which one or more embodiments of the invention can be implemented. By way of illustration, FIG. 13 depicts a distributed communications/computing network (processing platform) 1300 that includes a plurality of computing devices 1304-1 through 1304-P (herein collectively referred to as computing devices 704) configured to communicate with one another over a network 702. FIG. 13 further depicts a server 1306 configured to store database 1308. In one embodiment, the server is a cloud server. Database may be the database discussed herein above with reference to FIG. 1.

It is to be appreciated that one, more than one, or all of the computing devices 1304 in FIG. 13 may be configured as shown in FIG. 12. It is to be appreciated that the methodologies described herein may be executed in one such computing device 1304, or executed in a distributed manner across two or more such computing devices 1304. It is to be further appreciated that a server, a client device, a processing device or any other processing platform element may be viewed as an example of what is more generally referred to herein as a “computing device.” The network 1302 may include, for example, a global computer network such as the Internet, a wide area network (WAN), a local area network (LAN), a satellite network, a telephone or cable network, or various portions or combinations of these and other types of networks (including wired and/or wireless networks).

As described herein, the computing devices 1304 may represent a large variety of devices. For example, the computing devices 704 can include a portable device such as a mobile telephone, a smart phone, personal digital assistant (PDA), tablet, computer, a client device, etc. The computing devices 1304 may alternatively include a desktop or laptop personal computer (PC), a server, a microcomputer, a workstation, a kiosk, a mainframe computer, or any other information processing device, which can implement any or all of the techniques detailed in accordance with one or more embodiments of the invention.

One or more of the computing devices 1304 may also be considered a “user.” The term “user,” as used in this context, should be understood to encompass, by way of example and without limitation, a user device, a person utilizing or otherwise associated with the device, or a combination of both. An operation described herein as being performed by a user may therefore, for example, be performed by a user device, a person utilizing or otherwise associated with the device, or by a combination of both the person and the device, the context of which is apparent from the description.

Additionally, as noted herein, one or more modules, elements or components described in connection with embodiments of the invention can be located geographically-remote from one or more other modules, elements or components. That is, for example, the modules, elements or components shown and described in the context of FIGS. 1-11 can be distributed in an Internet-based environment, a mobile telephony-based environment, a kiosk-based environment and/or a local area network environment. The model management system, as described herein, is not limited to any particular one of these implementation environments. However, depending on the operations being performed by the system, one implementation environment may have some functional and/or physical benefits over another implementation environment.

The processing platform 1300 shown in FIG. 13 may comprise additional known components such as batch processing systems, parallel processing systems, physical machines, virtual machines, virtual switches, storage volumes, etc. Again, the particular processing platform shown in this figure is presented by way of example only, and may include additional or alternative processing platforms, as well as numerous distinct processing platforms in any combination. Also, numerous other arrangements of servers, clients, computers, storage devices or other components are possible in processing platform 1300.

Furthermore, it is to be appreciated that the processing platform 1300 of FIG. 13 can comprise virtual machines (VMs) implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1300 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor, which is directly inserted on top of the computer hardware in order to allocate hardware resources of the physical computer dynamically and transparently. The hypervisor affords the ability for multiple operating systems to run concurrently on a single physical computer and share hardware resources with each other.

It is to be appreciated that combinations of the different implementation environments are contemplated as being within the scope of embodiments of the invention. One of ordinary skill in the art will realize alternative implementations given the illustrative teachings provided herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Additionally, the terms “comprises” and/or “comprising,” as used herein, specify the presence of stated values, features, steps, operations, modules, elements, and/or components, but do not preclude the presence or addition of another value, feature, step, operation, module, element, component, and/or group thereof.

The online interactive website and interactive mobile application, in accordance with an embodiment of the present invention, can also provide resource information, such as where to find lawyers, and how to interact with law enforcement personnel.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method comprising:
maintaining a database comprising incident report data and personnel commentary data, wherein the incident report data comprises data associated with law enforcement incident reports;
wherein the database is in communication with at least one of an interactive mobile application and an interactive website over a communications network; and
providing a user with access to the database in response to receiving an access request from the user, wherein the user accesses the database over the communications network via one or both of the interactive mobile application and the interactive website;
wherein the at least one of the interactive mobile application and the interactive website comprise add incident report data functionality, add personnel commentary data functionality, and search functionality for at least one of the incident report data and the personnel commentary data maintained in the database; and
wherein the method is performed by at least one processing device comprising a processor operatively coupled to a memory.

2. The method according to claim 1, wherein providing the user with access to the database comprises receiving a request from the user to add new incident report data in response to user activation of the add incident report data functionality, and providing the user with an add incident report data page comprising one or more incident report page fields in response to the received request.

3. The method according to claim 2, wherein the one or more incident report page fields comprise one or more of country, state, county/parish, incident title, incident date, incident time, incident location, incident details, and attach one or more media files.

4. The method according to claim 1, wherein providing the user with access to the database comprises receiving a request from the user to add new personnel commentary data in response to user activation of the add personnel commentary data functionality, and providing the user with an add personnel commentary data page comprising one or more personnel commentary page fields in response to the received request.

5. The method according to claim 4, wherein the one or more personnel commentary page fields comprise one or more of country, state, county/parish, agency, review for, name/car/badge, rating, feedback, and attach media one or more media files.

6. The method according to claim 1, wherein providing the user with access to the database comprises receiving a request from the user to search the database for one or more of the incident report data and the personnel commentary data in response to user activation of the search functionality, and providing the user with a search page comprising one or more search page fields in response to the received request.

7. The method according to claim 6, wherein the one or more search page fields comprise one or more of country, state, zip code, review for, and name/car/badge number.

8. The method according to claim 1, wherein the at least one of the interactive mobile application and the interactive website further comprises popular data item search functionality.

9. The method according to claim 8, wherein providing the user access to the database comprises receiving a request from the user to search the database for a popular data item in response to user activation of the popular data item search functionality, and providing the user with a popular data item search page comprising one or more popular data item search page fields in response to the received request.

10. The method according to claim 9, wherein the one or more popular data item search page fields comprise one or more of country, state, county/parish, popularity, keyword, date.

11. The method according to claim 1, further comprising registering the user on the at least one of the interactive website and the interactive mobile application.

12. The method according to claim 11, wherein registering the user comprises logging the user in via at least one auxiliary account associated with the user.

13. The method according to claim 12, wherein the at least one auxiliary account is selected from the group consisting of: an e-mail account, a social media account, and another application account.

14. The method according to claim 1, wherein the database is stored on a cloud server.

15. The method according to claim 1, wherein the interactive mobile application is configured to permit the user record a video of a target using a mobile device, wherein the recorded video is at least one of automatically saved on the mobile device, and automatically sent via the communications network to a server and saved at the server.

16. The method according to claim 15, wherein the mobile device lacks any indication of recording while the recording of the video is occurring.

17. A system comprising:
at least one processing device comprising a processor operatively coupled to memory;
a communications network in communication with the at least one processing device; and
a database comprising incident report data and personnel commentary data and in communication with at least one of an interactive mobile application and an interactive website over the communications network, wherein the incident report data comprises data associated with law enforcement incident reports;
wherein the at least one of the interactive mobile application and the interactive website comprise add incident report data functionality, add personnel commentary data functionality, and search functionality for at least one of the incident report data and the personnel commentary data maintained in the database; and
wherein the at least one processing device is configured to:
maintain the database; and
provide a user with access to the database in response to receiving an access request from the user, wherein the user accesses the database over the communications network via one or both of the interactive mobile application and the interactive website.

18. An article of manufacture comprising a processor-readable storage medium having encoded therein executable code of one or more software programs, wherein the one or more software programs when executed by one or more processing devices implement the steps of:
maintaining a database comprising incident report data and personnel commentary data, wherein the incident report data comprises data associated with law enforcement incident reports;
wherein the database is in communication with at least one of an interactive mobile application and an interactive website over a communications network; and
providing a user with access to the database in response to receiving an access request from the user, wherein the user accesses the database over the communications network via one or both of the interactive mobile application and the interactive website;
wherein the at least one of the interactive mobile application and the interactive website comprise add incident report data functionality, add personnel commentary data functionality, and search functionality for at least one of the incident report data and the personnel commentary data maintained in the database.

19. The article of manufacture according to claim 18, wherein providing the user with access to the database comprises receiving a request from the user to add new incident report data in response to user activation of the add incident report data functionality, and providing the user with an add incident report data page comprising one or more incident report page fields in response to the received request.

20. The article of manufacture according to claim 18, wherein providing the user with access to the database comprises receiving a request from the user to add new personnel commentary data in response to user activation of the add personnel commentary data functionality, and providing the user with an add personnel commentary data page comprising one or more personnel commentary page fields in response to the received request.
